(19) United States
(12) Patent Application Publication
(10) Pub. No.: US 2008/0174592 A1
(43) Pub. Date: Jul. 24, 2008

(54) METHOD AND APPARATUS FOR CONTROLLING BACKLIGHT OF PORTABLE DISPLAY DEVICE

(75) Inventors: Hwang-Sik BAE, Suwon-si (KR); Joo-Kwang Kim, Yongin-si (KR); Won-Seok Heo, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 12/018,601

(22) Filed: Jan. 23, 2008

(30) Foreign Application Priority Data
Jan. 23, 2007 (KR) 2007-7087

(51) Int. Cl. H05B 41/38; G09G 5/00

(52) U.S. Cl. 345/212

(57) ABSTRACT

A method and apparatus for controlling a backlight of a portable display device for a portable communication system are disclosed. The method for controlling a backlight of a portable display device includes calculating a power adjustment coefficient by using information sensed according to a state where the portable display device makes contact with a human body, and adjusting power to be supplied for the backlight according to the calculated power adjustment coefficient. The portable display device controls the amount of power to be supplied according to states where the portable display device makes contact with a human body or is close to a human body to provide only a required amount of power, thus, it is possible to supply power for a longer period of time.

### PRIORITY

This application claims priority under 35 U.S.C. §119(a) to an application entitled “Method And Apparatus For Controlling Backlight Of Portable Display Device” filed in the Korean Intellectual Property Office on Jan. 23, 2007 and assigned Serial No. 2007-7087, the contents of which are incorporated herein by reference.

### BACKGROUND OF THE INVENTION

1. Field of the Invention

The present invention relates generally to a portable communication system, and in particular, to a method and apparatus for controlling a backlight of a portable display device.

2. Description of the Related Art

In modern society, people are being confronted with a life where they must collect and process various types of data by means of personal information devices or communication devices, regardless of time and place. Accordingly, popularity of portable devices which the users must carry for the ubiquitous life is gradually increasing, and the devices are being miniaturized for the convenience of the users.

The portable devices include, for example, communication devices, such as portable terminals, Personal Digital Assistants (PDA), small-sized computers, etc., and portable display devices, such as Portable Multimedia Players (PMP), Head-Mounted Displays (HMD), etc. In the following description, various portable devices equipped with a display means, such as a Liquid Crystal Display (LCD), etc., will be inclusively referred to as a “portable display device.”

Generally, a portable display device uses a battery, such as a charging battery, as a power source, while using a component, such as a backlight unit, consuming a large amount of power. Therefore, since such a conventional portable display device has a limited operation time characteristic, there is a need to develop a method for implementing a portable display device which can be used for a long time by efficiently controlling the consumption of power.

### SUMMARY OF THE INVENTION

Accordingly, the present invention has been made to solve the above-mentioned problems occurring in the prior art, and the present invention provides a method and apparatus for controlling a backlight through an efficient control of an operating power source in a portable display device.

In accordance with an aspect of the present invention, there is provided a method for controlling a backlight of a portable display device, the method including calculating a power adjustment coefficient by using information sensed according to a state where the portable display device makes contact with a human body, and adjusting power to be supplied for the backlight according to the calculated power adjustment coefficient.

In accordance with another aspect of the present invention, there is provided an apparatus for controlling backlight of a portable display device, the apparatus including an interface unit for outputting information sensed according to states where the portable display device makes contact with a human body, and a control unit for calculating a power adjustment coefficient by using the sensed information and adjusting power to be supplied for the backlight according to the calculated power adjustment coefficient.

### BRIEF DESCRIPTION OF THE DRAWINGS

The above and other aspects, features and advantages of the present invention will become more apparent from the following detailed description when taken in conjunction with the accompanying drawings, in which:

FIG. 1 is a block diagram illustrating the configuration of a portable display device having a backlight control apparatus according to the present invention;

FIG. 2 is a block diagram illustrating sensors included in the interface unit of FIG. 1; and

FIG. 3 is a flowchart illustrating a display method of a portable display device, to which the backlight control method according to the present invention is applied.

### DETAILED DESCRIPTION OF THE EXEMPLARY EMBODIMENT

Hereinafter, exemplary embodiments of the present invention will be described with reference to the accompanying drawings. In the following description, a detailed description of known functions and configurations incorporated herein will be omitted when it may obscure the subject matter of the present invention. Terms described in the following description are defined by taking functions thereof into consideration, so they may vary according to the users, operator's intention, or custom. Accordingly, the terms must be defined based on the entire contents of the present application.

First, a portable display device, to which the present invention is applied, includes all types of display devices, such as a Head-Mounted Display (HMD), an Liquid Crystal Display (LCD) panel, a cellular phone, Personal Digital Assistants (PDA), a Portable Multimedia Player (PMP), etc, having a backlight unit.

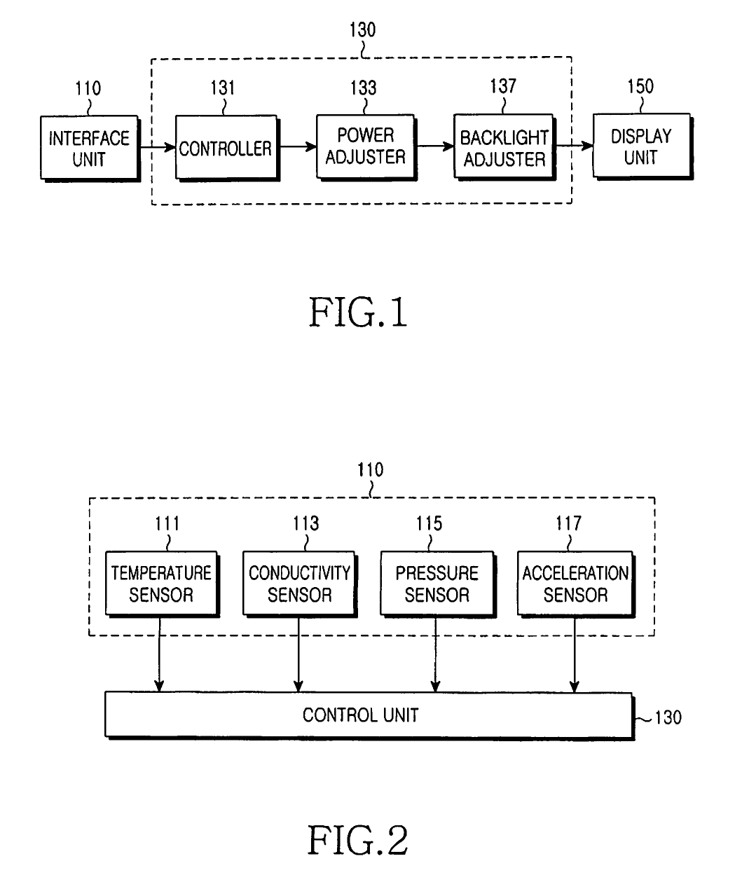

FIG. 1 is a block diagram illustrating the configuration of a portable display device having a backlight control apparatus according to a the present invention.

The portable display device includes an interface unit 110, a control unit 130, and a display unit 150. The interface unit 110 senses body temperature, conductivity, pressure, acceleration, etc. according to conditions (e.g. being mounted on a head, being held in a hand, being in a bag, etc.) on which the portable display device has been mounted, and outputs at least one piece of sensed information. The sensed information according to the conditions where the portable display device has been mounted may be obtained through sensors included in the interface unit 110. An example in which the sensors sense body temperature, conductivity, pressure, acceleration, etc. will be described in detail with reference to FIG. 2.

The control unit 130 includes a controller 131, a power adjuster 133, and a backlight adjuster 137. The controller 131 determines a state where the portable display device is currently in contact with a human body (as well as whether or not the apparatus is moving) by using at least one piece of sensed information input through the interface unit 110, as shown in Table 1. Then, the controller 131 calculates a Power Control (PC) coefficient for determining power to be supplied for the backlight according to a result of the determination, by means of Equation (1).

PC=function (ca*bt, cb*c, cc* p, cd*a) (1)

In Equation (1), “bt,” “c,” “p” and “a” are input sensed information, and represent body temperature, conductivity, pressure, and acceleration, respectively.

Also, “ca,” “cb,” “cc” and “cd” represent preset weight coefficients, and may be determined to be “0” with respect to sensed information having no connection with power adjustment. In addition, “function” enables a power adjustment coefficient to be calculated by means of the sensed information, as shown in Table 1.

TABLE 1

| | Power | Sensed information | | | |
|---|---|---|---|---|---|
| State of | Adjustment | Body | | | |
| Contact with | coefficient | Temperature | Conductivity | Pressure | Acceleration |
| Human Body | (PC) | (bt) | (c) | (p) | (a) |
| When worn on | 70% of | Temperature 1 | Conductivity 1 | Both-side | Constant |
| face: | normal | | | pressure 1 | |
| Contact with | power | | | | |
| both sides of | | | | | |
| face | | | | | |
| Parallel | | | | | |
| position | | | | | |
| When worn as | 0% of | Temperature 2 | Lower than | Lower | Constant |
| a head | normal | | conductivity 1 | than both- | after |
| ornament: | power | | | side | increase |
| Head contact | | | | pressure 1 | |
| Increase of | | | | | |
| fixation angle | | | | | |
| When held in | 100% of | Lower than | One-side/ | One-side/ | Constant |
| hand: | normal | temperature 2 | Both-side | Both-side | after |
| Contact with | power | | conduction | pressure | decrease |
| one side/both | | | | | |
| sides | | | | | |
| Non-fixed | | | | | |
| position | | | | | |
| When | 0% of | 0 | 0 | 0 | Constant |
| separated from | normal | | | | after change |
| human body: | power | | | | |
| No contact | | | | | |
| Other cases | adjustable | adjustable | adjustable | adjustable | adjustable |

In Table 1, the body temperature “bt” among sensed information is classified into “Temperature 1” for a range of temperatures (e.g. a range from 36° to 38°) corresponding to temperatures sensed upon face contact, “Temperature 2” for a range of temperatures (e.g. a range of temperatures lower than Temperature 2 defined above) corresponding to temperatures sensed upon head contact, and “Lower than Temperature 2” for a range of temperatures corresponding to temperatures sensed upon hand contact. Similarly to the body temperature “bt,” the conductivity “c” is classified into “Conductivity 1” for a range of conductivities corresponding to conductivities sensed upon face contact, “Lower than Conductivity 1” for a range of conductivities corresponding to conductivities sensed upon head contact, and “One-side/both-side conductivity” for a range of conductivities corresponding to one hand/both hands. Also, similarly to the conductivity “c,” the pressure “p” is classified into “Both-side Pressure 1” for a range of pressure corresponding to pressure sensed upon face contact, “Lower than Both-side Pressure 1” for a range of pressure corresponding to pressure sensed head contact, and “One-side/Both-side Pressure” for a range of pressure corresponding to one hand/both hands. Acceleration “a” is classified according to a change in an acceleration. In Table 1, the columns for the “other cases” have “adjustable” entered because they can be implemented in such a manner that the control unit 130 according to the present invention controls power to be output according to input sensed information.

The method for calculating a power adjustment coefficient when the controller 131 receives sensed information corresponding to a body temperature of 37° through the interface unit 110 will now be described with reference to Table 1, as an example. Since the body temperature of 37° corresponds to the “Temperature 1” in Table 1, the controller 131 determines that the portable display device is currently worn on the user's face, and calculates the power adjustment coefficient to be 70% of the normal power.

The power adjuster 133 adjusts power according to the calculated power adjustment coefficient and supplies the adjusted power to the backlight adjuster 137. Also, the power adjuster 133 may cut off power when power to be supplied is determined to 0% of the normal power based on a calculated power adjustment coefficient. Then, the backlight adjuster 137 adjusts the brightness of the backlight according to the supplied power. The display unit 150 displays input data with the adjusted brightness of the backlight.

FIG. 2 is a block diagram illustrating sensors included in the interface unit 110 of FIG. 1. The interface unit 110 in FIG. 2 includes at least one sensor among a temperature sensor 111, a conductivity sensor 113, a pressure sensor 115, and an acceleration sensor (e.g. gyro sensor) 117, as a sensor for sensing conditions where the portable display device has been mounted.

The temperature sensor 111 senses the temperature of the user's face when the portable display device has been mounted on the face, and senses the temperature of a user's hand when the user is holding the portable display device in his/her hand. Also, in case the portable display device is an HMD, the temperature sensor 111 senses a relatively higher temperature because the HMD makes contact with both sides of the user's face when making contact with the skin of the user, and senses a relatively lower temperature when the HMD has been mounted on a user's head. The conductivity sensor 113 senses a variation in a capacitance or the like when the portable display device makes contact with a human body, or becomes close to a human body. The pressure sensor 115 senses a pressure applied to the portable display device according to portions of a human body with which the portable display device makes contact. The gyro sensor 117 senses the movement of the portable display device. For example, the gyro sensor 117 may sense that the HMD is fixed at a relatively larger inclination when the HMD has been mounted on the user's head, than when the HMD has been mounted on the user's face.

The sensors included in the interface unit 110 input at least one piece of sensed information to the control unit 130. Then, the control unit 130 calculates different power adjustment coefficients depending on states where the portable display device makes contact with a human body, by means of the input sensed information, as shown in Table 1.

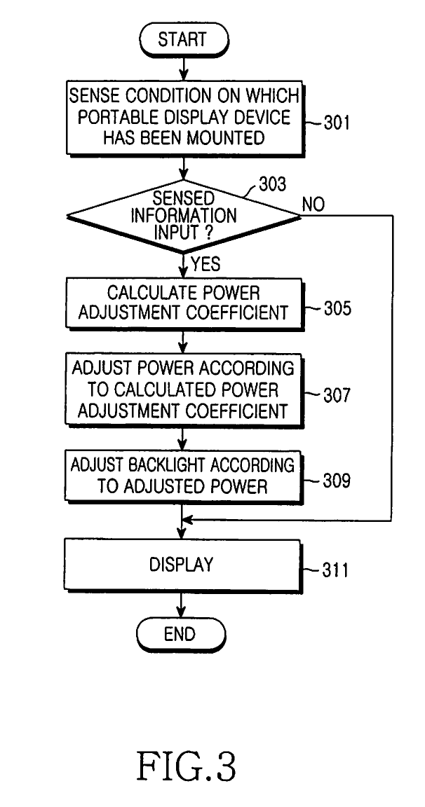

FIG. 3 is a flowchart illustrating a display method of a portable display device, to which the backlight control method according to the present invention is applied.

In step 301, the interface unit 110 senses body temperature, conductivity, pressure, acceleration, etc. according to conditions where the portable display device has been mounted, and outputs at least one of sensed values as sensed information. In step 303, the controller 131 determines if the controller has received the sensed information, and proceeds to step 305 when it is determined that the controller has received the sensed information. In contrast, when it is determined that the controller does not receive sensed information, the controller 131 performs a control operation such that the same power as that supplied at the prior stage is to be supplied to display input data.

In step 305, the controller 131 calculates a power adjustment coefficient for adjusting power supplied for the backlight by using Equation I with the input sensed information. Then, in step 307, the power adjuster 133 adjusts power according to the calculated power adjustment coefficient. In step 309, the backlight adjuster 137 adjusts the brightness of the backlight according to the adjusted power. In step 311, the display unit 150 displays input data in the adjusted brightness of the backlight.

As described above, it is possible to control the backlight by adjusting power according to states where the portable display device makes contact with a human body according to the present invention.

Also, according to the present invention, it is possible to improve the efficiency of power in a portable display device, such as an HMD, which makes contact with a human body and is able to be used for body communication.

The “body communication” has been developed from the fact that a human body has the characteristics of a conductor, and electric signals can be transmitted/received through the human body. Body communication is a technology of implementing data communication by using the human body as a medium material, like an electrical wire. Such body communication has advantages when an antenna is not used, and it makes easy to miniaturize devices owing to low power consumption and low cost, thus, its application in the personal area network field is expected to be increased in the future.

As described above, according to the present invention, the portable display device controls the amount of power to be supplied according to states where the portable display device makes contact with a human body or is close to a human body to provide only a required amount of power. Thus, it is possible to supply power for a longer period of time.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A method for controlling a backlight of a portable display device, the method comprising the steps of:
calculating a power adjustment coefficient using sensed information according to a state where the portable display device makes contact with a human body; and
adjusting power to be supplied for the backlight according to the calculated power adjustment coefficient.

2. The method as claimed in claim 1, wherein the sensed information includes a measured value of at least one of a human body's temperature, a conductivity, a pressure, and an acceleration, such that the human body's temperature, the conductivity, the pressure, and the acceleration are sensed according to conditions where the portable display device has been mounted.

3. The method as claimed in claim 1, wherein the state where the portable display device makes contact with the human body includes a state where the portable display device is worn on a face, a state where the portable display device is worn as a head ornament, a state where the portable display device is held in a hand, and a state where the portable display device is separated from the human body, according to the sensed information.

4. The method as claimed in claim 3, wherein, in the step of calculating the power adjustment coefficient, 0% of normal power is calculated as the power adjustment coefficient when the portable display device is worn as the head ornament or is separated from the human body, 100% of the normal power is calculated as the power adjustment coefficient when the portable display device is held in the hand, and a value greater than that calculated when the portable display device is separated from the human body, and less than that calculated when the portable display device is held in the hand, is calculated as the power adjustment coefficient when the portable display device is worn on the face.

5. An apparatus for controlling a backlight of a portable display device, the apparatus comprising:
an interface unit for outputting information sensed according to states where the portable display device makes contact with a human body; and
a control unit for calculating a power adjustment coefficient using the sensed information, and adjusting power to be supplied for the backlight according to the calculated power adjustment coefficient.

6. The apparatus as claimed in claim 5, wherein the interface unit includes at least one of a temperature sensor, a conductivity sensor, a pressure sensor, and an acceleration sensor, such that the temperature sensor, the conductivity sensor, the pressure sensor, and the acceleration sensor sense conditions where the portable display device has been mounted.

7. The apparatus claimed in claim 5, wherein the sensed information includes a measured value of at least one of a human body's temperature, a conductivity, a pressure, and an acceleration, such that the human body's temperature, the conductivity, the pressure, and the acceleration are sensed according to conditions where the portable display device has been mounted.

8. The apparatus as claimed in claim 5, wherein the state where the portable display device makes contact with the human body includes a state where the portable display device is worn on a face, a state where the portable display device is worn as a head ornament, a state where the portable display device is held in a hand, and a state where the portable display device is separated from the human body, according to the sensed information.

9. The apparatus as claimed in claim 8, wherein the control unit calculates 0% of normal power as the power adjustment coefficient when the portable display device is worn as the head ornament or is separated from the human body, calculates 100% of the normal power as the power adjustment coefficient when the portable display device is held in the hand, and calculates a value, which is greater than that calculated when the portable display device is separated from the human body, and less than that calculated when the portable display device is held in the hand, as the power adjustment coefficient when the portable display device is worn on the face.
